(19) United States
(12) Patent Application Publication
(10) Pub. No.: US 2013/0325643 A1
(43) Pub. Date: Dec. 5, 2013

(54) ISOLATED TRANSACTION

(71) Applicants: Nathan Dent, Charlotte, NC (US); Matthew K. Bryant, Gastonia, NC (US); Nicholas James Munson, Charlotte, NC (US)

(72) Inventors: Nathan Dent, Charlotte, NC (US); Matthew K. Bryant, Gastonia, NC (US); Nicholas James Munson, Charlotte, NC (US)

(73) Assignee: Bank of America, Charlotte, NC (US)

(21) Appl. No.: 13/484,544

(22) Filed: May 31, 2012

(51) Int. Cl. G06Q 30/06; G06Q 40/00

(52) U.S. Cl. 705/26.1; 705/44

(57) ABSTRACT

Apparatus, methods and media for providing a transaction between a customer and a merchant. The apparatus may include a processor that is configured to register in a machine readable memory a purchasing proxy that corresponds to the customer and the merchant; a receiver that is configured to receive from the merchant transaction information that includes the purchasing proxy; and a transmitter that is configured to transmit transaction authorization information to the merchant based on the transaction information and customer account information that is co-registered, in the machine readable memory, with the purchasing proxy.

### FIELD OF TECHNOLOGY

This application relates to providing transactions. More specifically, the application relates to isolating transaction information.

### BACKGROUND OF THE INVENTION

During a transactions, merchants often store customers' credit and debit card information for use in subsequent transactions, for example, when the transactions involve goods, services, subscriptions or, in general, serial purchases or transactions that involve recurring payments. The customers must depend on the robustness of the merchants' information security systems. If a merchant's data security is breached, the customers' credit or debit card information could be available for misuse until the merchant detects the breach and corrective action is taken.

The breach may interrupt provision of the goods, services, subscriptions, serial purchases and the like to the customer until different credit or debit card information is provided. Providing the new credit or debit card information may require that an issuer research fraudulent activity and issue new cards. The customer may need to undertake credit monitoring, assist the issuer with the research, initiate processes for replacing the cards, notify other merchants of the security breach, replace card information for future transactions with the other merchants and undergo other inconveniences associated with the breach. The merchant, and other merchants that also utilize the card information, may be exposed to fraudulent transaction risk and may be required to undertake risk mitigation measures.

It would be desirable, therefore, to provide apparatus, methods and media for providing transactions.

### SUMMARY OF THE INVENTION

Apparatus, methods and media for providing a transaction between a customer and a merchant are provided. The apparatus may include a processor that is configured to register in a machine readable memory a purchasing proxy that corresponds to the customer and the merchant; a receiver that is configured to receive from the merchant transaction information that includes the purchasing proxy; and a transmitter that is configured to transmit transaction authorization information to the merchant based on the transaction information and customer account information that is co-registered, in the machine readable memory, with the purchasing proxy.

The merchant may save the purchasing proxy for subsequent transactions with the customer.

In some embodiments, the receiver may be configured to receive a customer response to a proxy alert; the processor may be configured to set a risk condition flag based on the customer response; and the transmitter may be configured to transmit to a merchant a transaction authorization request denial based on the risk condition flag. The merchant may be a first merchant; the processor may be configured to identify the customer as the source of the risk condition flag; and the transmitter may be configured to transmit to a second merchant a transaction authorization request approval based on an authorization request for a transaction between the customer and the second merchant. The proxy alert may correspond to a purchasing proxy that is one of a plurality of purchasing proxies for the customer; and the processor may be further configured to receive a proxy management instruction from the customer, the proxy management instruction associating the purchasing proxy with a customer account of the customer.

In some embodiments, the receiver may be configured to receive merchant security breach information; and the processor may be configured to: (1) deny authorization requests for transactions between each of a plurality of customers and a first merchant; and (2) approve authorization requests for transactions between each of the plurality of customers and a second merchant. The proxy alert may correspond to a purchasing proxy that is one of a plurality of purchasing proxies for the customer; and the processor may be configured to receive a proxy management instruction from the customer. The proxy management instruction may associate the purchasing proxy with a customer account of the customer. The receiver may be configured to receive from a merchant a first request for authorization based on a purchasing proxy that is associated with a customer transaction instrument that is unknown to the merchant; and the transmitter may be configured to provide to an issuer a second request for authorization based on a customer account that is associated with the purchasing proxy and the transaction instrument. The transmitter may be configured to provide to the merchant an approval of the first request. The approval may include the purchasing proxy and may not identify the customer transaction instrument.

The processor may be configured to transmit to the customer a purchasing proxy alert that alerts the customer about use of the purchasing proxy in connection with a prospective transaction. The processor may be configured to transmit to the customer a purchasing proxy alert that alerts the customer about use of the purchasing proxy in connection with a transaction in progress. The processor may be configured to transmit to the customer a purchasing proxy alert that alerts the customer about use of the purchasing proxy in connection with a completed transaction.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative arrangement in which apparatus and methods in accordance with the principles of the invention may be used;

FIG. 2 shows illustrative information in accordance with the principles of the invention;

FIG. 3 shows other illustrative information in accordance with the principles of the invention;

FIG. 4 shows another illustrative arrangement in which apparatus and methods in accordance with the principles of the invention may be used;

FIG. 5 shows the arrangement of FIG. 4 in a state that is different from that shown in FIG. 4;

FIG. 6 shows an illustrative outcome of using the apparatus and methods in connection with the arrangement shown in FIG. 4;

FIG. 7 shows the arrangement of FIG. 4 in another state that is different from that shown in FIG. 4;

FIG. 8 shows another illustrative outcome of using the apparatus and methods in connection with the arrangement shown in FIG. 4;

FIG. 9 shows illustrative apparatus that may be used in accordance with the principles of the invention;

FIG. 10 shows illustrative elements of a process in accordance with the principles of the invention;

FIG. 11 shows illustrative elements of another process in accordance with the principles of the invention;

FIG. 12 shows illustrative elements of yet another process in accordance with the principles of the invention;

FIG. 13 shows illustrative elements of still another process in accordance with the principles of the invention;

FIG. 14 shows illustrative elements of still another process in accordance with the principles of the invention;

FIG. 15 shows illustrative information in accordance with the principles of the invention; and

FIG. 16 shows other illustrative information in accordance with the principles of the invention.

### DETAILED DESCRIPTION OF THE INVENTION

Apparatus, methods and media are provided for providing a transaction between a customer and a merchant. One or more of the methods may be performed using some or all of the apparatus. One or more of the media may include instructions for machine performance of some or all of the methods.

The transaction may be performed at a brick-and-mortar venue. The transaction may performed on-line. The transaction may be performed by voice over “plain old telephone service.” The transaction may be performed by voice over IP. The transaction may be performed by text message. The transaction may be performed by any suitable combination of the above or by any other suitable approach.

The transaction may include the provision of goods, services or both (collectively, “the goods”) by the merchant to the customer. An acquirer, which may be a financial institution, may pay the merchant for the goods and require reimbursement from an issuer, which may be a financial institution, that has provided a funds account to the customer. The issuer may provide a transaction instrument to the customer. The customer may use the transaction instrument to direct the issuer to pay for the goods using funds from the account. The merchant may query the issuer for authentication of the customer, for authorization to execute the transaction or for any other suitable purpose, in connection with the transaction.

The transaction instrument may include a paper check, a credit card, a debit card, an instrument or device that includes a contact chip, such as an ISO14443-compliant contactless chip, or other suitable electronic purchasing device.

The issuer may provide the transaction instrument with an instrument identification number. The issuer may associate the instrument identification number with the customer. The issuer may associate the instrument identification number with the account.

The apparatus may include, and the methods may involve, a processor that is configured to register in a machine readable memory a purchasing proxy.

The purchasing proxy may include a code, reference number or any other suitable information. The issuer may associate the proxy with the customer, the merchant and the transaction instrument or the account, or both the transaction instrument and the account. The proxy may then be used in communication between the merchant and the issuer instead of the transaction instrument.

The issuer may provide the purchasing proxy to the customer for use in transactions with the merchant. The customer may present the purchasing proxy to the merchant when the merchant requests a “form of payment” from the customer. For example, in a series of on-line shopping cart forms, the merchant may provide the customer with a fill-in box in which the customer can enter the purchasing proxy. The merchant may save the purchasing proxy for subsequent transactions with the customer. In the subsequent transactions, the merchant may prepopulate the “form of payment” form with an indication that the customer will pay by purchasing proxy. In the subsequent transactions, the merchant may prepopulate the form with the purchasing proxy itself.

The purchasing proxy may correspond to the customer and the merchant. The purchasing proxy may correspond to the customer, to the merchant and to no other merchant. The purchasing proxy may correspond to the merchant, the customer and to no other customer.

The apparatus may include, and the methods may involve, a receiver that is configured to receive from the merchant transaction information that includes the purchasing proxy.

Table 1 shows illustrative transaction information.

TABLE 1
Illustrative transaction information.
Illustrative transaction information

Transaction instrument identification information
Merchant identification information
Transaction date
Transaction time
Stock-keeping unit (“SKU”) identifiers
SKU prices
Transaction total amount
Merchant-side customer identification information
Merchant-side customer affinity program information
Purchasing proxy identification information
Transaction instrument issuer information (e.g., a bank issuer
number (“BIN”))
Financial institution customer account information
Financial institution routing identification information
Transaction processing network identification information
Transaction amount information
Electronic Fund Transfer information
ACH information
Other suitable information

The apparatus may include, and the methods may involve, a transmitter that is configured to transmit transaction authorization information to the merchant based on the transaction information and customer account information that is co-registered, in the machine readable memory, with the purchasing proxy.

In some embodiments, the receiver may be configured to receive a customer response to a proxy alert; the processor may be configured to set a risk condition flag based on the customer response; and the transmitter may be configured to transmit to a merchant a transaction authorization request denial based on the risk condition flag. The merchant may be a first merchant; the processor may be configured to identify the customer as the source of the risk condition flag; and the transmitter may be configured to transmit to a second merchant a transaction authorization request approval based on an authorization request for a transaction between the customer and the second merchant. The proxy alert may correspond to a purchasing proxy that is one of a plurality of purchasing proxies for the customer; and the processor may be further configured to receive a proxy management instruction from the customer, the proxy management instruction associating the purchasing proxy with a customer account of the customer.

In some embodiments, the receiver may be configured to receive merchant security breach information; and the processor may be configured to: (1) deny authorization requests for transactions between each of a plurality of customers and a first merchant; and (2) approve authorization requests for transactions between each of the plurality of customers and a second merchant. The proxy alert may correspond to a purchasing proxy that is one of a plurality of purchasing proxies for the customer; and the processor may be configured to receive a proxy management instruction from the customer. The proxy management instruction may associate the purchasing proxy with a customer account of the customer. The receiver may be configured to receive from a merchant a first request for authorization based on a purchasing proxy that is associated with a customer transaction instrument that is unknown to the merchant; and the transmitter may be configured to provide to an issuer a second request for authorization based on a customer account that is associated with the purchasing proxy and the transaction instrument. The transmitter may be configured to provide to the merchant an approval of the first request. The approval may include the purchasing proxy and may not identify the customer transaction instrument.

The processor may be configured to transmit to the customer a purchasing proxy alert that alerts the customer about use of the purchasing proxy in connection with a prospective transaction. The processor may be configured to transmit to the customer a purchasing proxy alert that alerts the customer about use of the purchasing proxy in connection with a transaction in progress. The processor may be configured to transmit to the customer a purchasing proxy alert that alerts the customer about use of the purchasing proxy in connection with a completed transaction.

The alerts may be transmitted by regular mail. The alerts may be transmitted by telephone. The alerts may be transmitted by text message. The alerts may be transmitted by electronic mail. The alerts may be posted on a web site.

The processor may be configured to cancel the transaction based on a customer response to the alert. The customer response may be transmitted by regular mail. The customer response may be transmitted by telephone. The customer response may be transmitted by text message. The customer response may be transmitted by electronic mail. The customer response may be posted on a web site.

The customer response may be a “DISMISSAL” of the alert. The customer response may be an “ALARM” in response to the alert. The customer response may be an “INQUIRY” for information about the transaction. The customer response may be a “PANIC SIGNAL.” The panic signal may be an alarm that includes an indication of heightened urgency. The panic signal may be initiated by the customer and not in response to the alert.

The customer response may be a behavior such as not responding to an alert.

The processor may be configured to cancel the transaction based on a time elapsed after transmission of the alert to the customer and before receipt of a customer response.

The merchant may be one of a plurality of merchants. The purchasing proxy may be one of a plurality of transaction instrument proxies. Each of the proxies may correspond to the customer and to a different one of the merchants. The processor may be configured to freeze the purchasing proxy corresponding to a first of the merchants, and to not freeze the purchasing proxy corresponding to a second of the merchants, in response to a customer security breach. A customer security breach may be a breach of security measures that protect information in the possession, or under the control, of the customer.

The customer may be one of a plurality of customers. The purchasing proxy may be one of a plurality of transaction instrument proxies. Each of the proxies may correspond to a different one of the customers and all of the proxies may correspond to the merchant. The processor may be configured to freeze the plurality of transaction instrument proxies in response to a merchant security breach. A merchant security breach may be a breach of security measures that protect information in the possession, or under the control, of the merchant.

The receiver may be configured to receive from each of the customers a panic signal. The panic signal may be a customer response. The customer may initiate the panic signal without first receiving an alert. The processor may be configured to freeze proxies of customers that transmit to the receiver a panic signal.

The processor may be configured to detect a pattern in communications received from customers. The Communications may include customer responses. The communications may include panic signals. The pattern may be based on communications from a single customer. The pattern may be based on communications from multiple customers. The pattern may be a temporal pattern. For example, multiple customers may send an alarm within a defined time period. The pattern may be a geographic pattern. For example, multiple customers may send an alarm within a defined geographical region. The pattern may be a logical pattern. For example, multiple customers that are linked to a category, such as customers that do business with a particular merchant or financial institution, may all send an alarm.

The processor may set a risk condition flag if the pattern satisfies a risk threshold. The risk threshold may be a number of alarms within the time period, a number of alarms within the geographical region, or a number of alarms within the category. The threshold may be based on one or more of the time period, the geographical region, the category or any other suitable attributes.

The memory may store a merchant report log that logs risk related events reported by merchants. The memory may store a customer report log that logs risk related events reported by customers. The memory may store a customer response log that logs customer responses to proxy alerts. The memory may store a customer proxy management instructions in a log. The processor may use one or more rules to analyze the logs to determine whether to set the risk condition flag.

A risk flag source may be identified in connection with each event for use in determining the scope of preventive actions.

Table 2 shows illustrative rules.

TABLE 2
Illustrative rules for determining whether to set a risk condition flag.

| | | Set risk | |
|---|---|---|---|
| | | condition | |
| | | flag to | |
| | | “RISK” if | Risk flag |
| | Event | event is . . . | source |
| Merchant | Security breach reported | “YES” | Merchant |
| Report Log | and not resolved | | |
| | Number of customer | >THRESHOLD A | Merchant |
| | “ALARM”s received | | |
| | from other customers in | | |
| | time period | | |
| | Number of customer | >THRESHOLD B | Merchant |
| | “ALARM”s received | | |
| | from other customers in | | |
| | postal code of transaction | | |
| Customer | Panic signal received | “YES” | Customer |
| Report Log | and not resolved | | |
| | Number of “ALARM”s | >THRESHOLD C | Customer |
| | received in time period | | |
| | Number of “ALARM”s | >THRESHOLD D | Customer |
| | received in time postal | | |
| | code of transaction | | |
| | Number of “ALARM”s | >THRESHOLD E | Customer |
| | received in response to | | |
| | past N customer alerts | | |
| | Elapsed time between | >THRESHOLD F | Customer |
| | current customer alert | | |
| | and customer response | | |
| Customer | Transaction amount | >THRESHOLD F | Customer |
| Proxy | Transactions per time | >THRESHOLD G | Customer |
| Management | period | | |
| Instructions | Transactions in | >THRESHOLD H | Customer |
| Log | geographical region | | |

One or more of thresholds A-H may be set by a system administrator. One or more of thresholds A-H may be set by customer C. One or more of thresholds A-H may be a metric, such as an average or other statistical descriptor, that is based on past merchant events. One or more of thresholds A-F may be a metric, such as an average or other statistical descriptor, that is based on past customer events. For example, if on average a customer responds to proxy alerts within 15 seconds, the threshold may be set to 60 seconds, which is four times the average. If the current response time is greater than 60 seconds, the risk condition flag may be set to “RISK.”

The transmitter may be configured to transmit to the merchant, before freezing the plurality of transaction instrument proxies, the risk condition flag.

The processor may be configured to register in the machine readable memory a replacement proxy for each of the transaction instrument proxies in response to the risk condition flag. The transmitter is configured to transmit to each of the customers the replacement proxies.

The processor may be configured to receive from the customer a purchasing proxy management instruction. The merchant may not have access to the purchasing proxy management instruction. The merchant may not have access to an outcome of the purchasing proxy management instruction.

The purchasing proxy may be registered as an authorization engine record in the machine readable memory. The purchasing proxy management instruction may cause a change in the record. The merchant may not have access to the change.

The purchasing proxy may be a limited-use proxy. For example, the limited-use proxy may be a single-use proxy that is limited to a single transaction. The single-use proxy may be configured, for example in the authorization engine record, to be frozen immediately after consummation of the transaction.

The transaction may be a person-to-person transaction. For example, the transaction may be a transaction between two individuals. One of the individuals may act as the merchant. The other may act as the customer. In such embodiments, the merchant or the customer may create a single-use proxy to be used once for the purpose of executing the transaction. The use of the proxy may obviate the need for the customer to provide to the merchant a transaction instrument or transaction instrument information. For example, the transaction instrument may be a check. The check may include information that the customer may want to protect from the merchant. For example, the check may include, in whole or in part, a routing number, an account number and a signature. The transaction could thus be executed without exchange of transaction instrument information.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

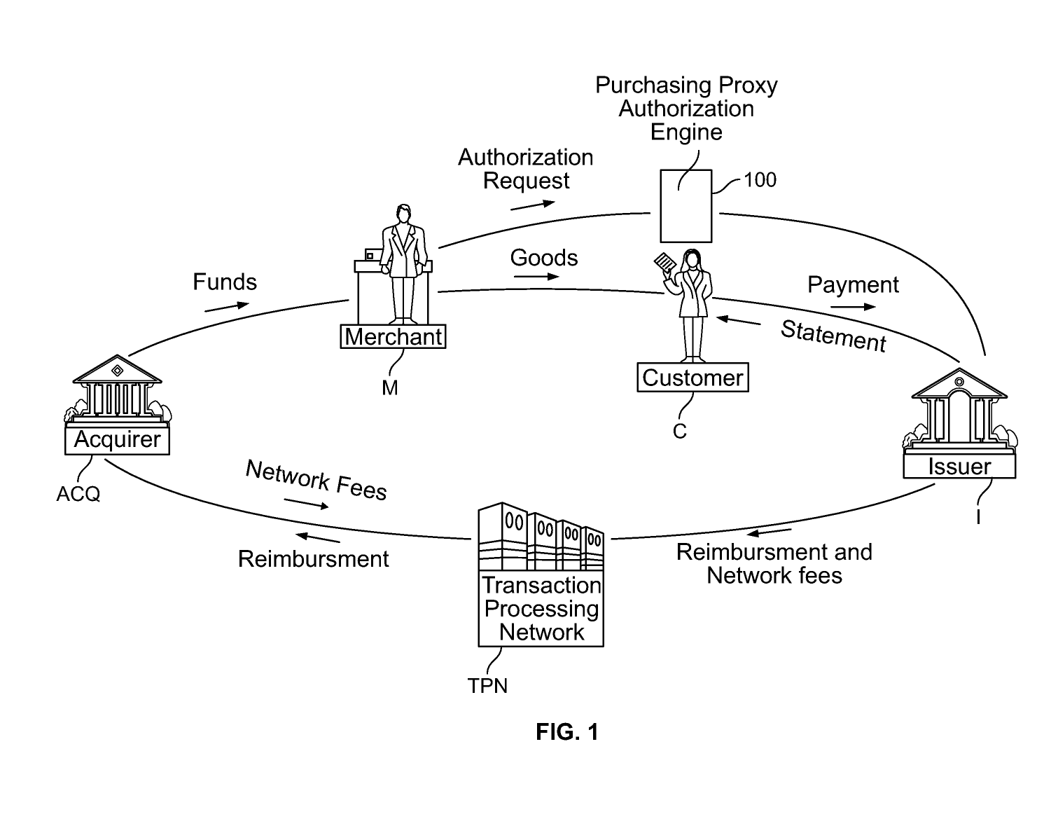

FIG. 1 shows purchasing proxy engine 100. Purchasing proxy engine 100 may receive a transaction authorization request from merchant M. The request may be a query as to whether customer C holds or has credit in sufficient funds in an account in issuer I to consummate the transaction. The authorization request may include a purchasing proxy that is associated with the account. Purchasing proxy engine 100 may use the purchasing proxy to identify the account for issuer I. Purchasing proxy 100 may be under the control and possession of issuer I. Purchasing proxy 100 may be a separate entity from issuer I. Purchasing proxy 100 may not include enough information for identification, in the absence of other confidential information, of the account or a transaction instrument that is associated with the account, by an entity other than purchasing proxy engine 100.

FIG. 1 shows that acquirer ACQ may transmit funds to merchant M to pay for the goods. Customer C may acquire the goods from merchant M. Issuer I may reimburse acquirer ACQ, via transaction processing network TPN. Customer C may make payment to issuer I for the goods.

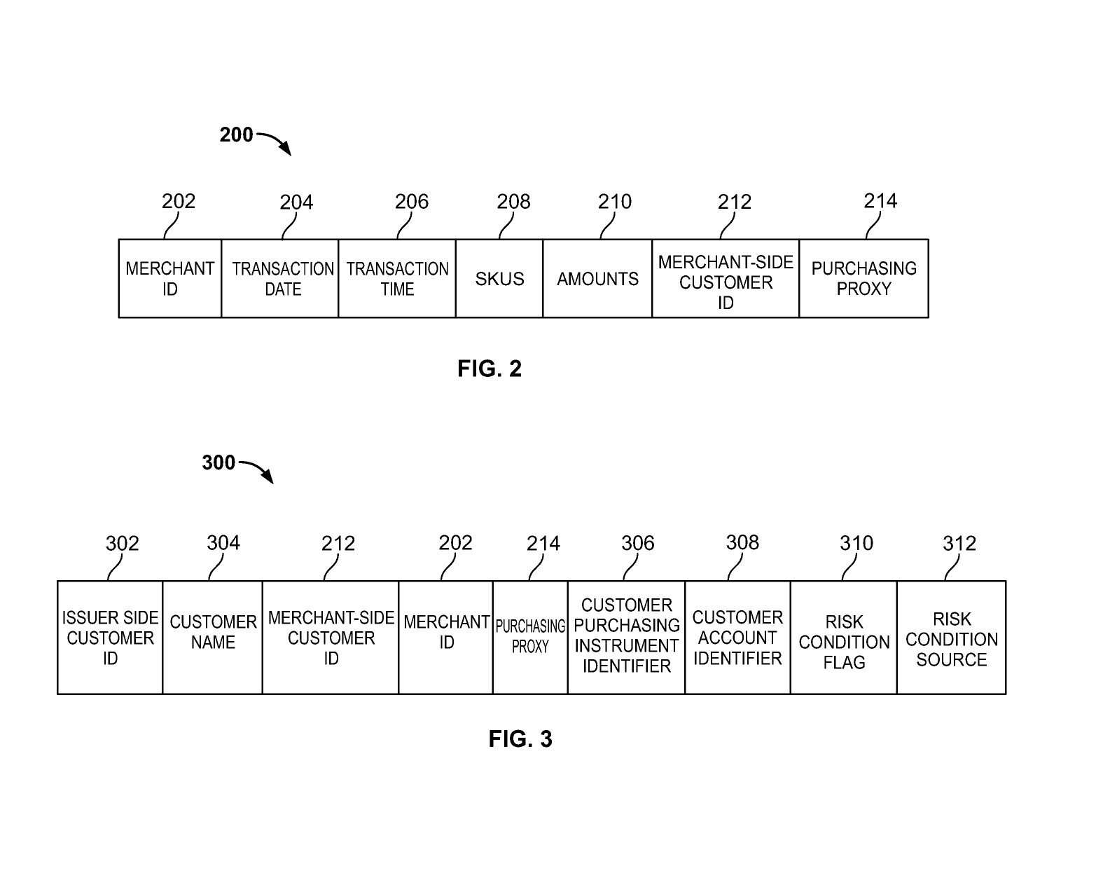

FIG. 2 shows illustrative transaction record 200. A merchant, such as M (shown in FIG. 1), may generate transaction record 200 in connection with the transaction. Merchant M may transmit transaction record 200 to a purchasing proxy authorization engine such as 100 (shown in FIG. 1).

Transaction record 200 may include merchant identifier 202. Merchant identifier 202 may be a merchant name or code that identifies the merchant to the issuer. Transaction record 200 may include transaction date 204. Transaction record 200 may include transaction time 206. Transaction record 200 may include stock-keeping unit (“SKU”) identifiers 208. SKU identifiers 208 may identify one or more goods that are part of the transaction. Transaction record 200 may include amounts 210. Amounts 210 may include one or more amounts that correspond to SKU identifiers 208. Transaction record 200 may include customer identifier 212. Merchant-side customer identifier 212 may be a name or code that identifies a customer such as C (shown in FIG. 1) to the issuer. Transaction record 200 may include proxy 214.

FIG. 3 shows illustrative authorization engine record 300. Record 300 may include issuer-side customer identifier 302. An issuer such as I (shown in FIG. 1) may use issuer-side customer identifier 302 to identify customer C in a manner that is unknown to entities other than issuer I. Record 300 may include customer name 304. Customer name 304 may be a publicly known name for customer C. Record 300 may include merchant-side customer identifier 112. Record 300 may include merchant identifier 102. Record 300 may include purchasing proxy 214.

Record 300 may include customer transaction instrument identifier 306, which may correspond to a transaction instrument number, such as a credit or debit card number.

Record 300 may include customer account identifier 308, which may correspond to a customer account, such as a checking account or a credit card account, held by customer C at issuer I.

Record 300 may include risk condition flag 310. Purchasing proxy engine 100 may use risk condition flag 310 to indicate whether proxy 214 is frozen or unfrozen. When risk condition flag 310 is set to “RISK,” proxy 214 may be frozen and unavailable for use in a transaction. When risk condition flag 310 is set to “AVAILABLE,” proxy 214 may be available for use in a transaction. The default state of risk condition flag 310 may be “AVAILABLE.”

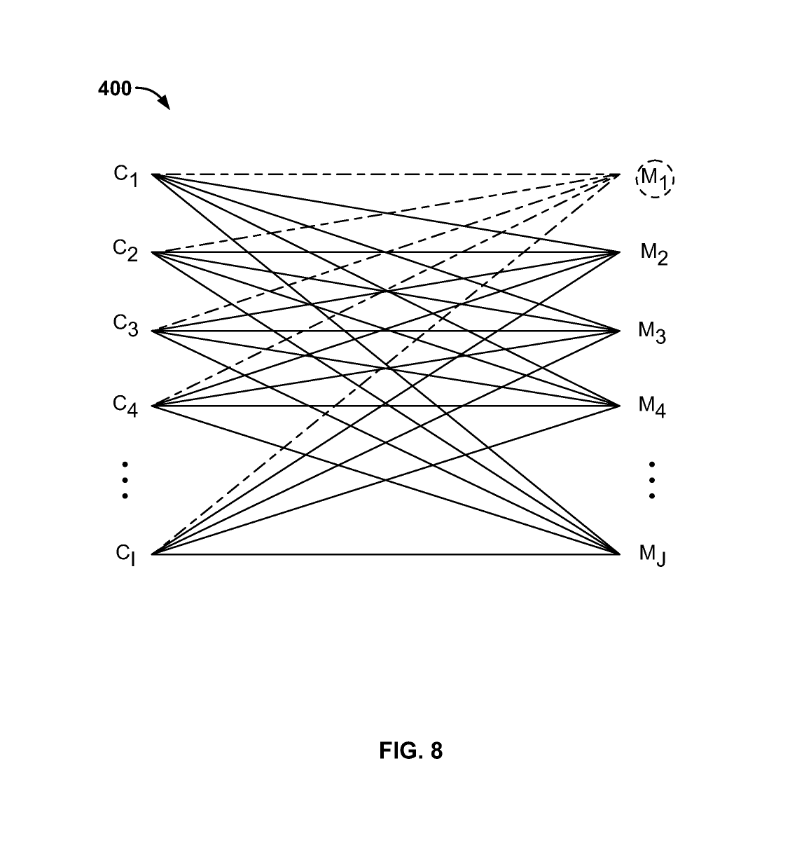

Record 300 may include risk condition source 312. Risk condition source 310 may indicate the source of a risk condition. For example, the risk condition may be based on a customer security breach, a merchant security breach or both. Risk condition source 312 may be used to determine the scope of preventive action that is required to offset the risk condition. For example, when risk condition source 312 is “CUSTOMER,” proxy 214 may be frozen. When risk condition source 312 is “MERCHANT,” all proxies linked to the merchant may be frozen, as shown schematically is FIG. 8.

Purchasing proxy engine 100 may use transaction record 200 and authorization engine record 300 to provide to issuer I information required for issuer I to authorize the transaction in amounts 110 (shown in FIG. 1).

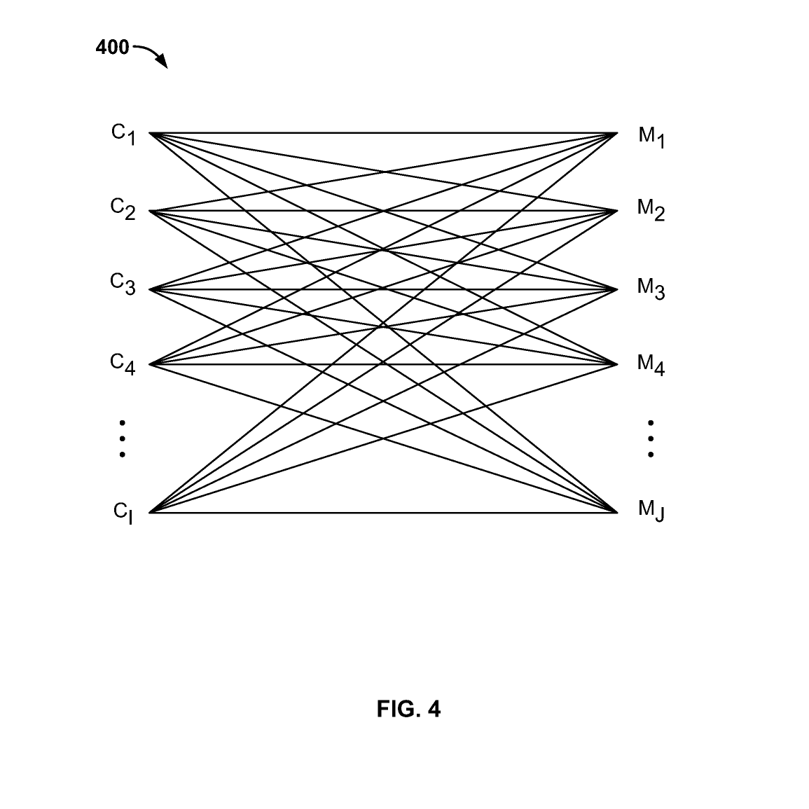

FIG. 4 shows illustrative relationships 400 between customers Cᵢ and merchants M. Customer C may be one of customers Cᵢ. Merchant M may be one of merchants M. Each of the relationships is a possible path for exchanging transaction information.

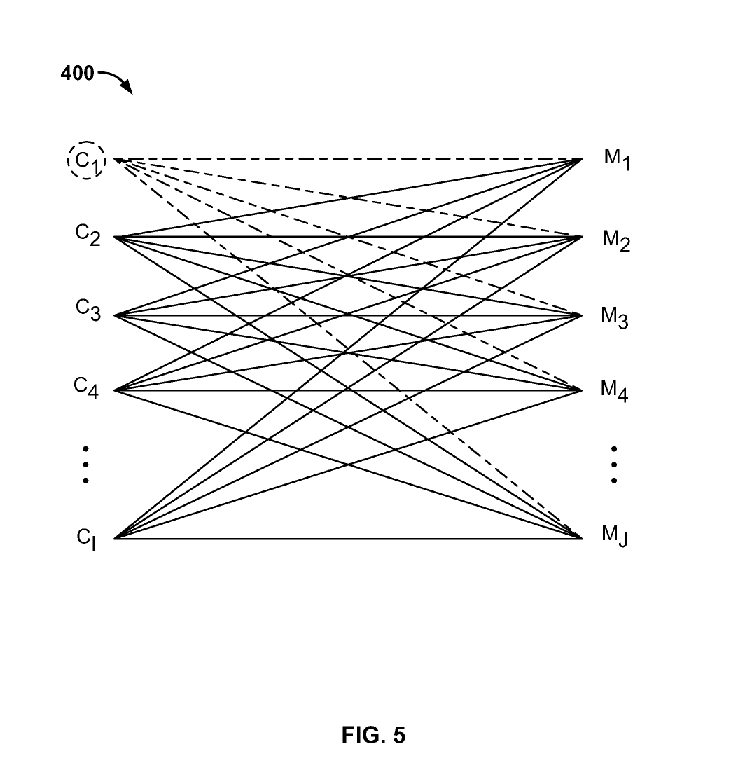

FIG. 5 shows relationships 400 after a security breach at customer C₁, when the transaction information includes transaction instrument or customer account identifiers. Broken lines indicate relationships in which unauthorized use of the transaction information may occur. If an unauthorized person were to obtain the transaction instrument or customer account information, the unauthorized person may use it to perform transactions, using funds of customer C₁, with merchants M₁-M_{J}.

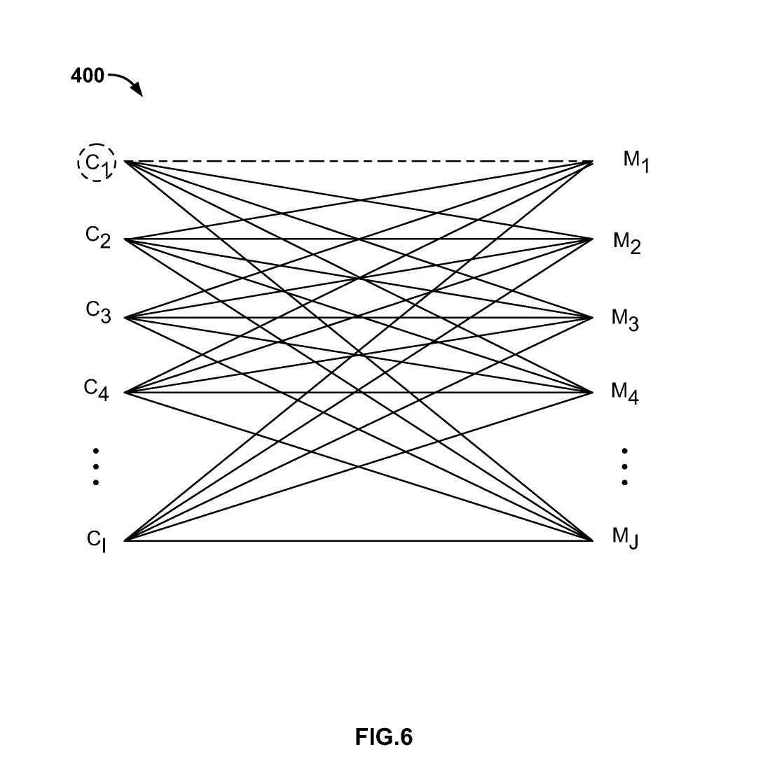

FIG. 6 shows relationships 400 when the transaction information does not include transaction instrument or customer account identifiers and instead includes purchasing proxies. If an unauthorized person were to obtain the purchasing proxy, the unauthorized person may use it to perform transactions only with the merchant, for example M₁, to whom the proxy corresponds.

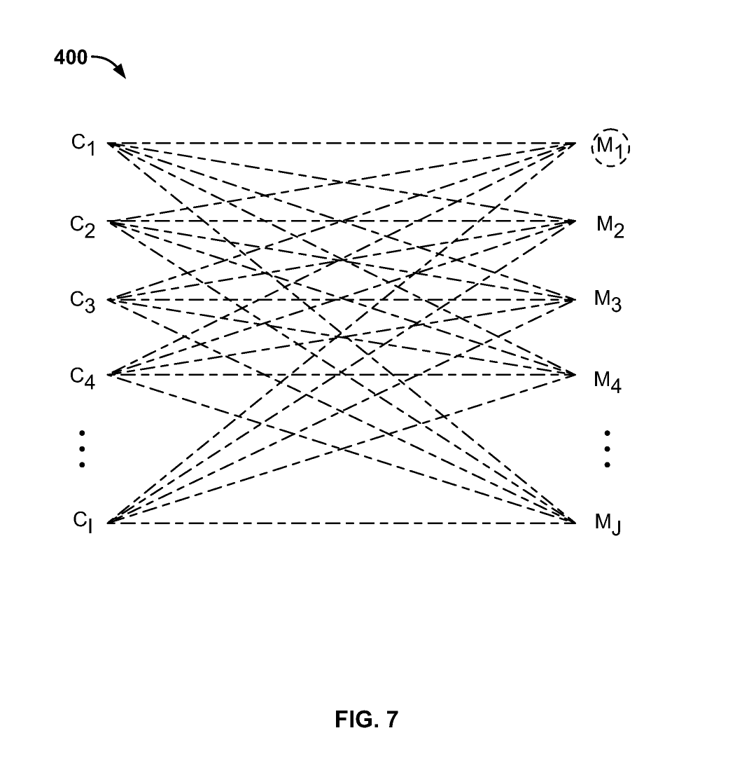

FIG. 7 shows relationships 400 after a security breach at merchant M₁, when the transaction information includes, and M₁ stores, transaction instrument or customer account identifiers. Broken lines indicate relationships in which unauthorized use of the transaction information may occur. For example, if an unauthorized person were to obtain from merchant M₁ transaction instrument or customer account information that pertains to customers C₁-CI, the unauthorized person may use it to perform transactions, using the funds of all of customers C₁-C_{I}, with merchants M₁-M_{J}.

FIG. 8 shows relationships 400 when the transaction information does not include transaction instrument or customer account identifiers and instead includes purchasing proxies. If an unauthorized person were to obtain the purchasing proxies from M₁, the unauthorized person may use the proxies to perform transactions, using the funds of customers C₁-C_{I}, only with merchant M₁, to whom the proxies correspond.

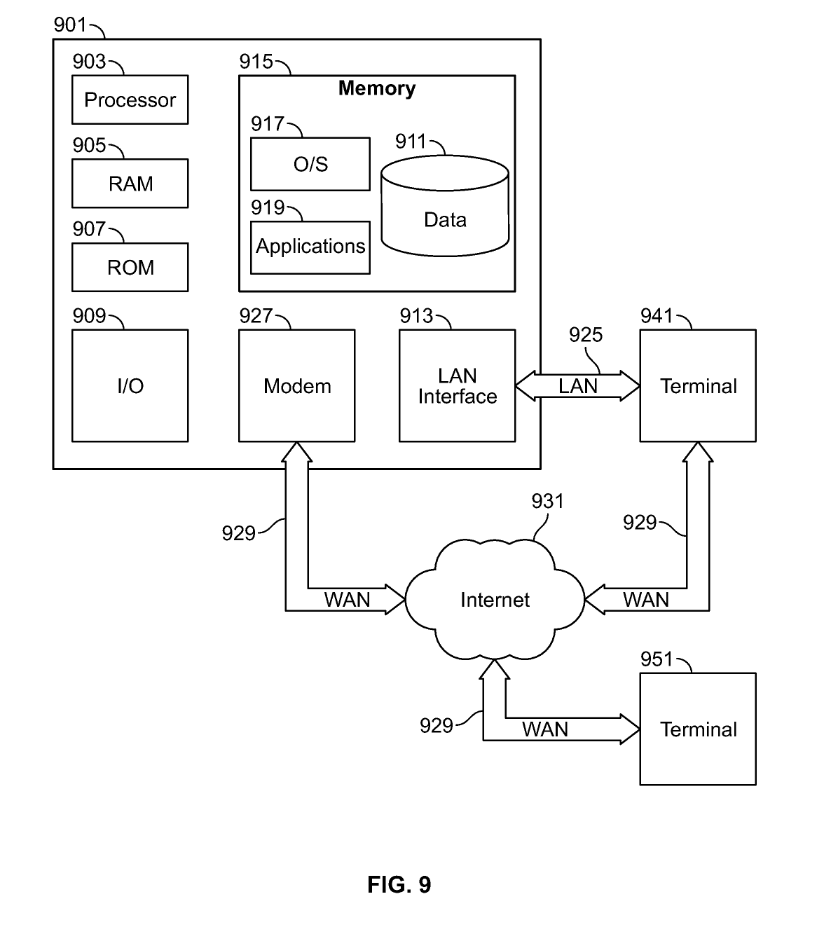

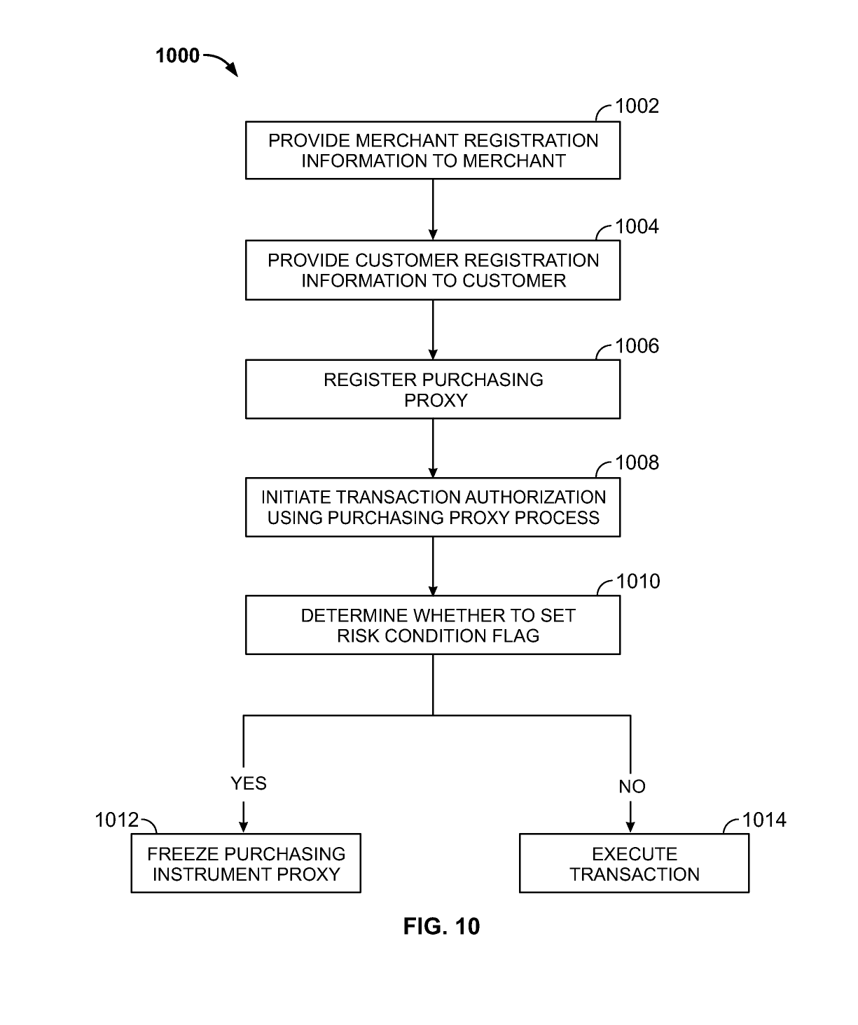

FIG. 9 is a block diagram that illustrates a generic computing device 901 (alternatively referred to herein as a “server”) that may be used in accordance with the principles of the invention. Server 901 may be included in any suitable apparatus that is shown or described herein. Server 901 may have a processor 903 for controlling overall operation of the server and its associated components, including RAM 905, ROM 907, input/output module 909, and memory 925.

Input/output (“I/O”) module 909 may include a microphone, keypad, touch screen, and/or stylus through which a user of device 901 may provide input, and may also include one or more of a speaker for providing audio output and a video display device for providing textual, audiovisual and/or graphical output. Software may be stored within memory 925 and/or storage to provide instructions to processor 903 for enabling server 901 to perform various functions. For example, memory 925 may store software used by server 901, such as an operating system 917, application programs 919, and an associated database 921. Alternatively, some or all of server 901 computer executable instructions may be embodied in hardware or firmware (not shown).

Server 901 may operate in a networked environment supporting connections to one or more remote computers, such as terminals 941 and 951. Terminals 941 and 951 may be personal computers or servers that include many or all of the elements described above relative to server 901. The network connections depicted in FIG. 9 include a local area network (LAN) 925 and a wide area network (WAN) 929, but may also include other networks. When used in a LAN networking environment, computer 901 is connected to LAN 925 through a network interface or adapter 923. When used in a WAN networking environment, server 901 may include a modem 927 or other means for establishing communications over WAN 929, such as Internet 931. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 919, which may be used by server 901, may include computer executable instructions for invoking user functionality related to communication, such as email, short message service (SMS), and voice input and speech recognition applications.

Computing device 901 and/or terminals 941 or 951 may also be mobile terminals including various other components, such as a battery, speaker, and antennas (not shown).

Terminal 951 and/or terminal 941 may be portable devices such as a laptop, cell phone, Blackberry™, or any other suitable device for storing, transmitting and/or transporting relevant information.

Any information described above in connection with database 921, and any other suitable information, may be stored in memory 925.

One or more of applications 919 may include one or more algorithms that may be used to process transaction information, purchase proxies, transaction authorization requests, transaction authorization information, and/or perform any other suitable tasks related to processing invoice data.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Processes in accordance with the principles of the invention may include one or more features of the processes illustrated in FIGS. 10-14. For the sake of illustration, the steps of the illustrated processes will be described as being performed by a “system.” The “system” may include one or more of the features of the apparatus shown in FIG. 9 and/or any other suitable device or approach. The “system” may be provided by an entity. The entity may be an individual, an organization or any other suitable entity.

FIG. 10 shows illustrative process 1000 for providing a transaction. Process 1000 may begin at step 1002. At step 1002, the system may provide merchant registration information to merchant M. The merchant registration information may include formatting information with which merchant M can formulate authorization requests that use purchasing proxies. The merchant registration information may include a merchant identifier, such as merchant identifier 202 (shown in FIG. 2), to identify merchant M when merchant M presents an authorization request to authorization engine 100 (shown in FIG. 1).

At step 1004, the system may provide customer registration information to customer C. The customer registration information may include formatting information with which customer C can formulate authorization requests that use purchasing proxies. The customer registration information may include a merchant identifier, such as customer identifier 302 (shown in FIG. 3), to identify customer C when customer C presents an authorization request to authorization engine 100 (shown in FIG. 1).

At step 1006, the system may register in memory a purchasing proxy such as 214 (shown in FIG. 2). The system may co-register with purchasing proxy 214 a customer transaction instrument identifier such as 306 or a customer account number such as 308.

At step 1008, the system may initiate a transaction authorization process using purchasing proxy 214. The system may receive an authorization request from merchant M, use purchasing proxy 214 to identify a customer C account corresponding to customer account identifier 308, initiate an authorization process on the customer C account, receive an authorization message (e.g., “AUTHORIZED” or “NOT AUTHORIZED”) for the transaction, and transmit the authorization message to merchant M.

The transaction may include a “check-out” process. The check-out process may be an on-line process. The check-out process may include a virtual shopping cart. The check-out process may include a payment type selection in which merchant M provides to customer C a form in which customer C may indicate a payment preference. The form may include options such as “CREDIT CARD,” “DEBIT CARD,” “ELECTRONIC CHECK,” or any other suitable payment option. The form may include “PURCHASING PROXY” as a payment option. Customer C may choose one of the options. If customer C chooses “PURCHASING PROXY,” merchant M may direct customer C to a web site of a financial institution.

The customer account for customer C may be maintained at the financial institution. The web site may provide customer C with an opportunity to an account at the financial institution.

The financial account web site may exchange information with customer C to link a transaction instrument or an account with a purchasing proxy, such as purchasing proxy 214 (shown in FIG. 2).

The system may transmit the authorization message to M along with the purchasing proxy. The system may transmit the authorization message to M along with other information that was included in the transaction information. The system may transmit the authorization message to M along with only the purchasing proxy. The system may transmit a portion of the authorization message to merchant M. The system may transmit a modified version of the authorization message to merchant M.

At step 1010, the system may determine whether to set a risk condition flag. If the flag is set, process 1000 may continue at step 1012. At step 1012, the system may freeze the purchasing proxy such that it cannot be used to authorize a transaction. If at step 1010, the flag is not set, process 1000 may continue at step 1014. At step 1014, the system may execute the transaction.

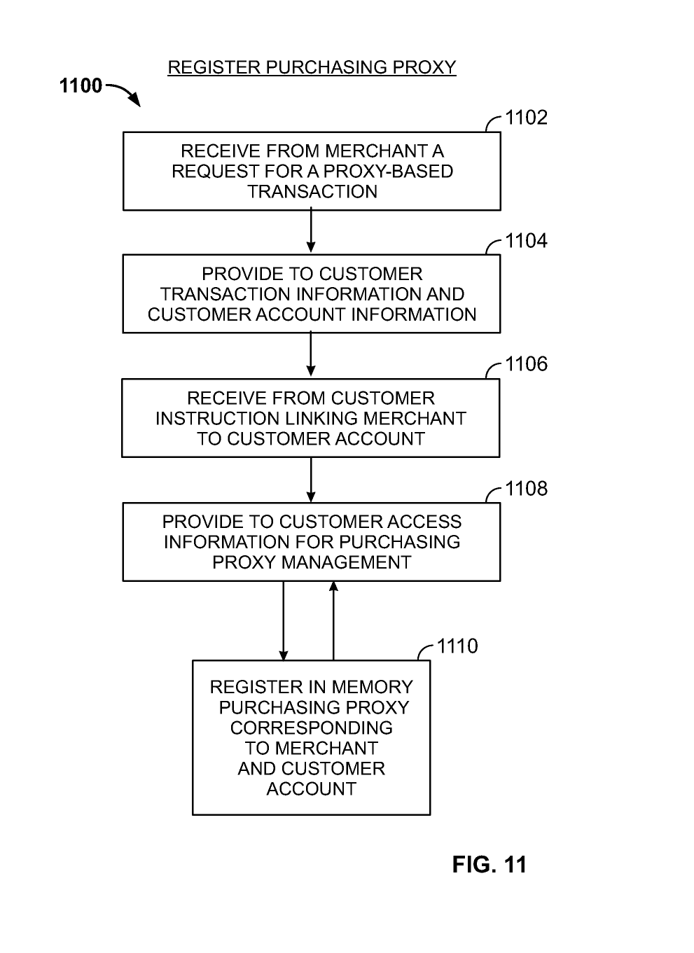

FIG. 11 shows illustrative process 1100. The system may execute one or more of the steps of process 1100 in connection with the execution of step 1004 of process 1000 (shown in FIG. 10).

Process 1100 may begin at step 1102. At step 1102, the system may receive from merchant M a request for a proxy-based transaction. At step 1104, the system may provide to customer C transaction information for the transaction and customer account information for an account held by customer C at the financial institution. At step 1106, the system may receive from customer C an instruction to link a new purchasing proxy to a transaction instrument of customer C or an account of customer C. The purchasing proxy may be linked to merchant M and the transaction instrument or account for this and future transactions between merchant M and customer C.

At step 1108, the system may provide to customer C access information for purchasing proxy management. Purchasing proxy management may be based on purchasing proxy management information that customer C may exchange with the system, for example, via a web site.

The access information may include a login and password for the web site. Customer C may use the web site to store purchasing proxies and information regarding merchants, transaction instruments and accounts that are linked to the purchasing proxies. Customer C may use the web site to change purchasing proxies and information regarding merchants, transaction instruments and accounts that are linked to the purchasing proxies. Customer C may use the web site to add purchasing proxies and information regarding merchants, transaction instruments and accounts that are linked to the purchasing proxies. Customer C may use the web site to delete purchasing proxies and information regarding merchants, transaction instruments and accounts that are linked to the purchasing proxies.

Customer C may use the web site to change the status of purchasing proxies. For example, customer C may place a purchasing proxy on “HOLD.” Customer C may use the web site to set operational limits on the proxy. Operation limits may include limits on transaction amounts, transaction amounts in a time period, SKUs for which the proxy may be used or any other suitable limits.

At step 1110, the system may register in memory a purchasing proxy corresponding to merchant M and the customer C transaction instrument or account. Changes in proxy management information may be recursively exchanged with customer C at step 1108 and registered in memory at step 1110. Merchant M, in the course of a transaction, may obtain a purchasing proxy, but merchant M may have no access to the purchasing proxy management information that is exchanged in step 1108 and registered in step 1110.

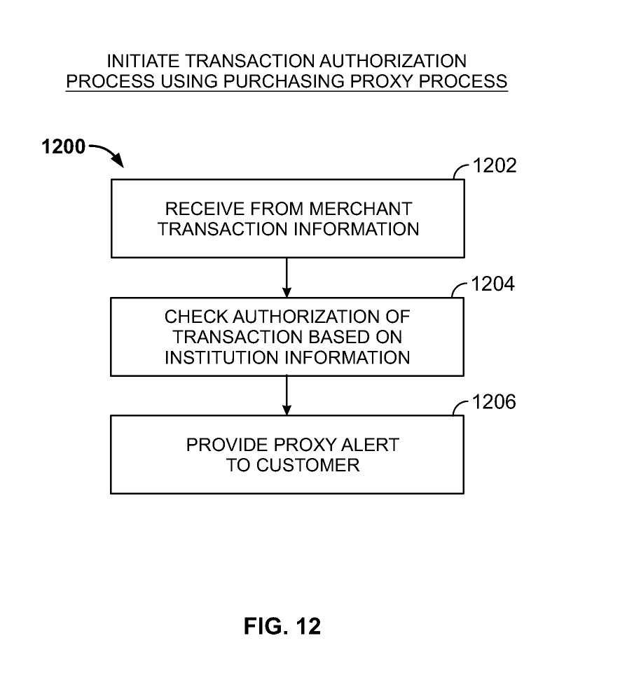

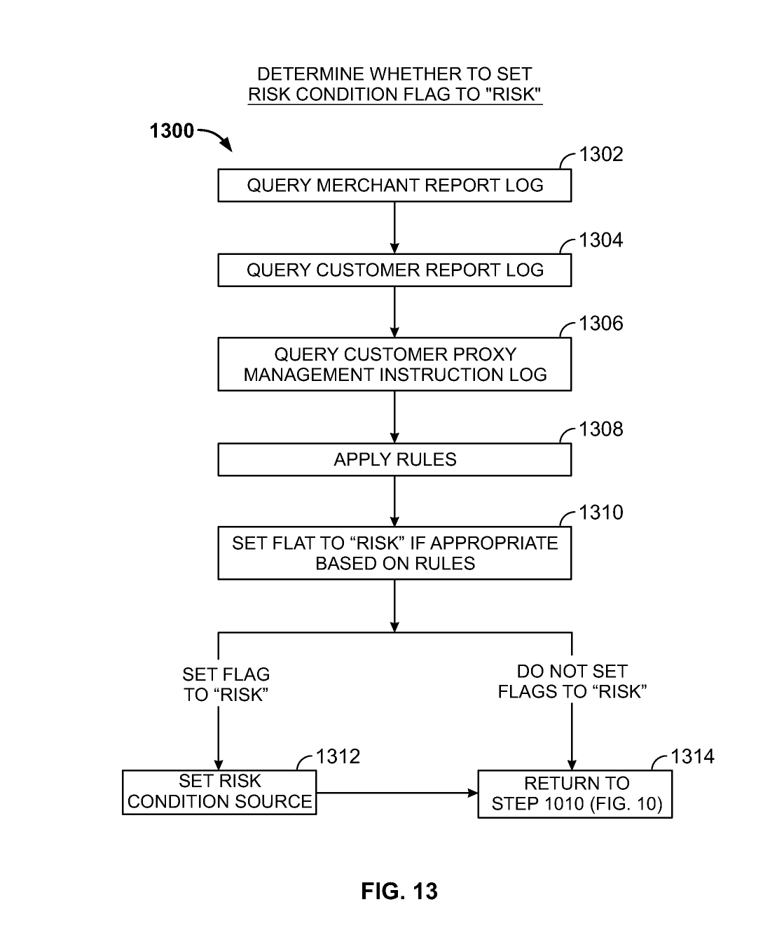

FIG. 12 shows illustrative process 1200. The system may execute one or more of the steps of process 1200 in connection with the execution of step 1008 of process 1000 (shown in FIG. 10).

Process 1200 may begin at step 1202. At step 1202, the system may receive from merchant M transaction information about the transaction between merchant M and customer C. The transaction information may include a purchasing proxy such as purchasing proxy 214 (shown in FIG. 2). A purchasing proxy engine such as 100 (shown in FIG. 1) may identify a customer account such as an account identified by customer account identifier 306 (shown in FIG. 3).

At step 1204, the system may use account identifier 306 to request authorization from issuer I or to initiate an authorization process in issuer I. Issuer I may conduct any suitable authorization analysis to determine whether to authorize the transaction.

At step 1206 the system may provide to customer C a proxy alert. The proxy alert may alert customer C to the use or prospective use of the proxy in a transaction. At step 1208, the system may “listen” for a response to the proxy alert. The listening may record customer responses and response times.

FIG. 13 shows illustrative process 1300. The system may execute one or more of the steps of process 1300 in connection with the execution of step 1010 of process 1000 (shown in FIG. 10).

Process 1300 may begin at step 1302. At step 1302, the system may query a merchant report log, such as that identified in Table 2, for the merchant identified in the transaction information in step 1202 (shown in FIG. 12). At step 1304, the system may query a customer report log, such as that identified in Table 2. At step 1306, the system may query a customer proxy management instructions log, such as that identified in Table 2. At step 1308, the system may apply one or more rules, such as those identified in Table 2, to the log information.

At step 1310, the system may, based on the outcome of the rule or rules, set risk condition flag 310 (shown in FIG. 3) to “RISK.” If at step 1310 the system sets risk condition flag 310 to “RISK,” the process 1300 may continue at step 1312. At step 1312, the system may set risk condition source 312 to a value of “MERCHANT,” if the merchant is the source of the risk or “CUSTOMER,” if the customer is the source of the risk.

If at step 1310, the system does not set risk condition flag 310 to “RISK,” process 1300 may continue at step 1314. At step 1314, process 1300 may return control to step 1010 (shown in FIG. 10).

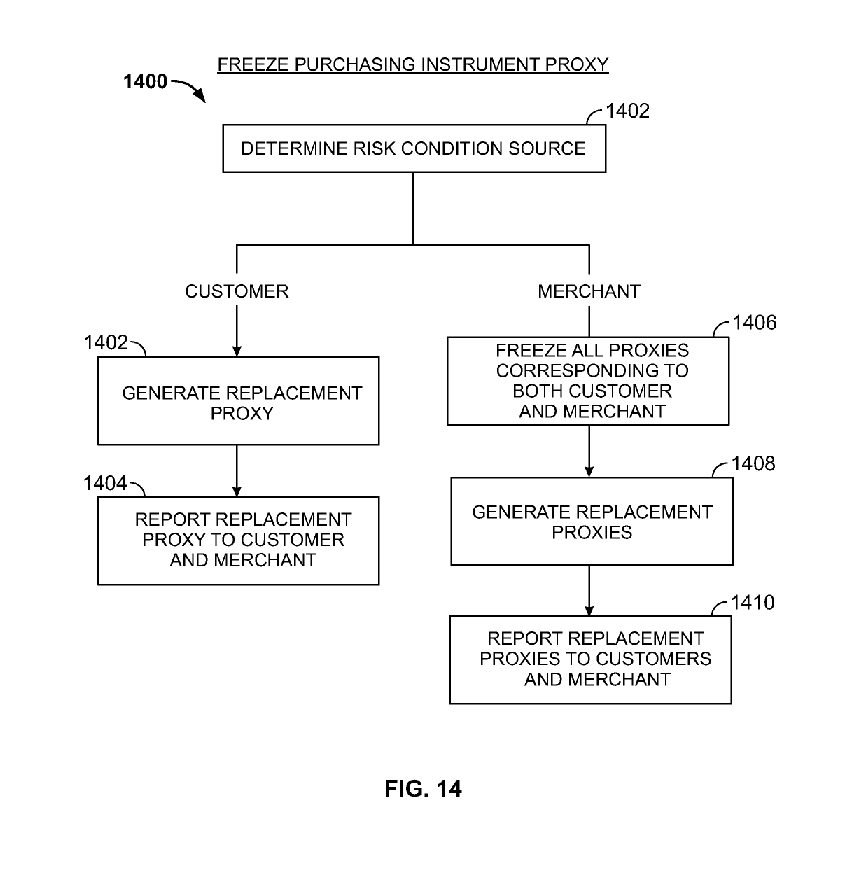

FIG. 14 shows illustrative process 1400. The system may execute one or more of the steps of process 1400 in connection with the execution of step 1012 of process 1000 (shown in FIG. 10).

Process 1400 may begin at step 1402. At step 1402, the system may query record 300 to determine if risk condition source 312 is “CUSTOMER” or “MERCHANT.” If risk condition source 312 is “CUSTOMER,” proxy 214 is frozen and no further proxies may be required to be frozen. Process 1400 may continue at step 1402. At step 1402, the system may generate a replacement proxy for the frozen proxy. At step 1404, the system may report the replacement proxy to customer C and merchant M.

If risk condition source 312 is “MERCHANT,” process 1400 may continue at step 1406. At step 1406, the system may freeze all proxies that are in place between merchant M and any customers. This may limit the risk to other customers as shown in FIG. 8. At step 1408, the system may generate replacement proxies to replace the frozen proxies. At step 1410, the system may report the replacement proxies to the merchant and the customers.

The system may include an override to un-freeze frozen proxies upon determination that a freeze was unfounded.

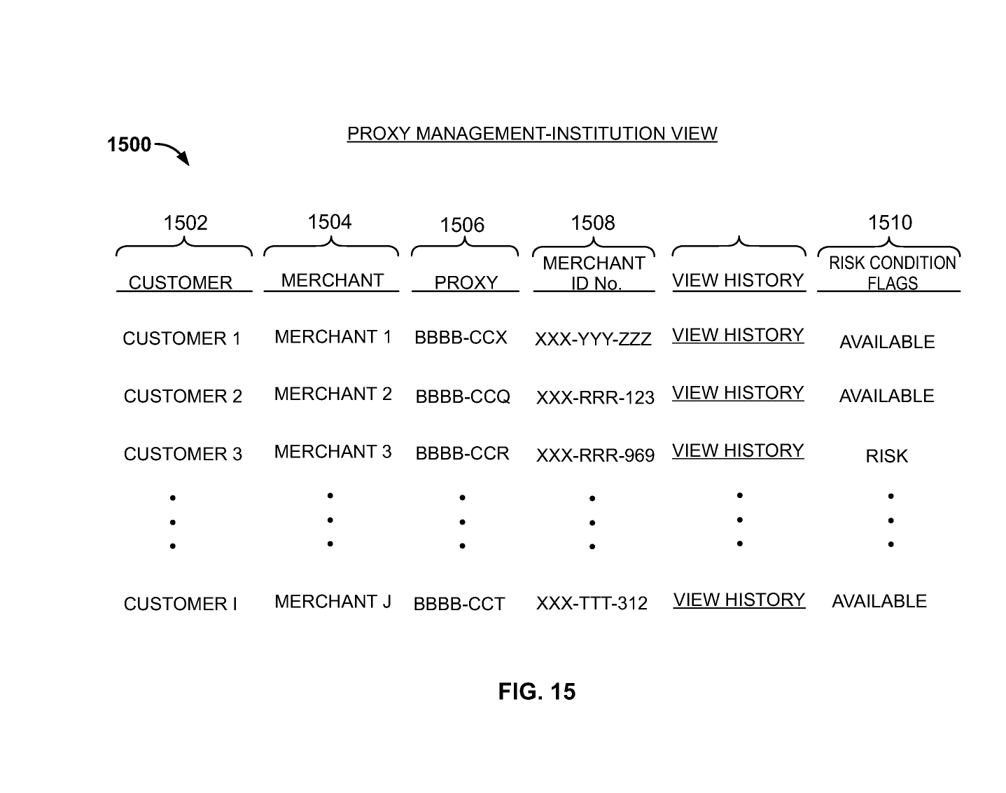

FIG. 15 shows illustrative information 1500. The system may present all or some of information 1500 to issuer I in connection with one or more purchasing proxies that issuer I may make available to customers C₁-C_{I} in connection with transactions between the customers and merchants M₁-M_{J}. Information 1500 may include customer names 1502. Information 1500 may include merchant names 1504. Information 1500 may include purchasing proxies 1506. Information 1500 may include merchant identifiers 1508.

Information 1500 may include for each proxy a “view history” link that provides issuer I with historical events connected with the proxy. For example, the view history link may provide issuer I with access to a merchant report log such as that identified in Table 2. Information 1500 may include indicator 1510 that shows the value of risk condition flag 310 (shown in FIG. 3) for each proxy.

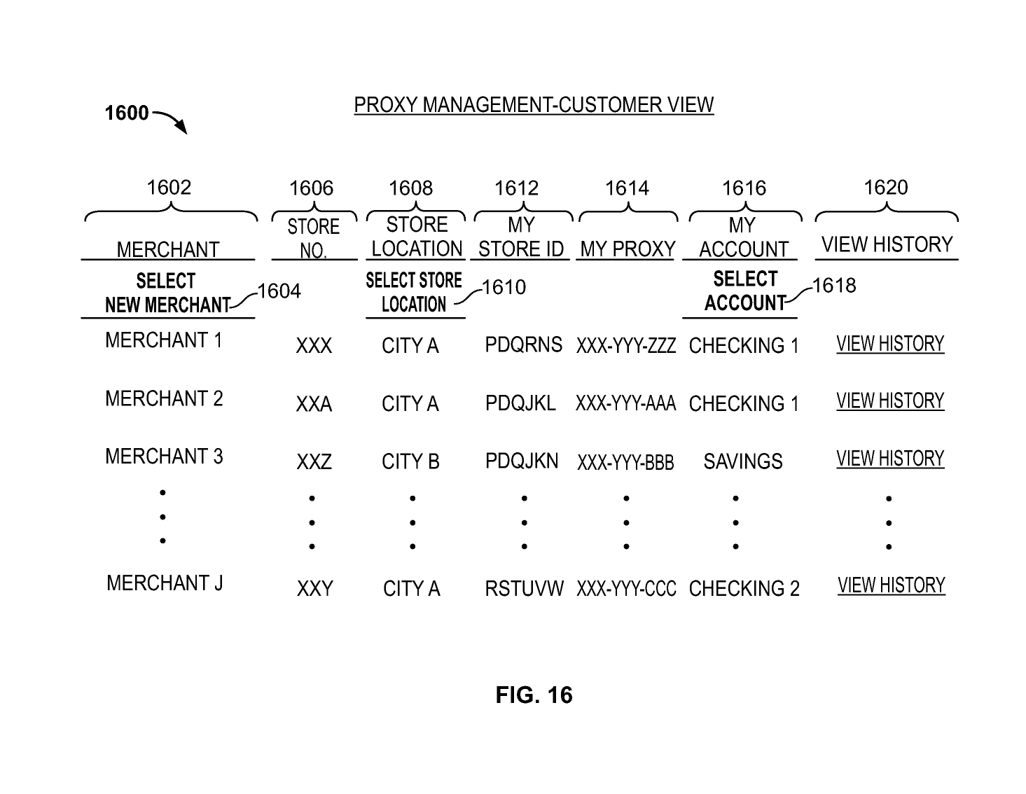

FIG. 16 shows illustrative information 1600. The system may present all or some of information 1600 to customer C in connection with one or more purchasing proxies that customer C may have registered for transactions with one or more of merchants M₁-M_{J}. Information 1600 may include merchant names 1602. Information 1602 may include link 1604 for adding a new merchant for registration of a new proxy.

Information 1600 may include store number 1606 for each merchant. Information 1600 may include store location for each merchant. Information 1600 may include link 1610 for adding, selecting or deleting a store location. Information 1600 may include “My Store ID” 1612, which may be a customer ID, assigned by the merchant to customer C, for each of the merchants and stores. Information 1600 may include “My Proxy” 1614, which may include purchasing proxies for each of the merchants and stores. Information 1600 may include “My Account” 1616, which may include customer accounts, held by customer C at issuer I, to which each of the proxies is linked.

Information 1600 may include “Select Account” link 1618, which customer C may use to add, delete or change an account that is linked to each of the proxies. Information 1600 may include “view history” links, which may be used to view historical events connected with the proxy. For example, the view history link may provide customer C with access to a customer report log such as that identified in Table 2.

Thus, apparatus and methods for providing a transaction between a customer and a merchant have been provided. Persons skilled in the art will appreciate that the present invention can be practiced by other than the described embodiments, which are presented for purposes of illustration rather than of limitation. The present invention is limited only by the claims that follow.

What is claimed is:

1. Apparatus for providing a transaction between a customer and a merchant, the apparatus comprising:
a processor that is configured to register in a machine readable memory a purchasing proxy that corresponds to the customer and the merchant;
a receiver that is configured to receive from the merchant transaction information that includes the purchasing proxy; and
a transmitter that is configured to transmit transaction authorization information to the merchant based on the transaction information and customer account information that is co-registered, in the machine readable memory, with the purchasing proxy.

2. The apparatus of claim 1 wherein the transmitter is further configured to transmit to the customer a purchasing proxy alert that alerts the customer about use of the purchasing proxy in connection with a prospective transaction.

3. The apparatus of claim 1 wherein the transmitter is further configured to transmit to the customer a purchasing proxy alert that alerts the customer about use of the purchasing proxy in connection with a transaction in progress.

4. The apparatus of claim 3 wherein the processor is further configured to cancel the transaction based on a customer response to the alert.

5. The apparatus of claim 3 wherein the processor is further configured to cancel the transaction based on a time elapsed after transmission of the alert and before receipt of a customer response.

6. The apparatus of claim 1 wherein the processor is further configured to transmit to the customer a purchasing proxy alert that alerts the customer about use of the purchasing proxy in connection with a completed transaction.

7. The apparatus of claim 1 wherein:
the merchant is of a plurality of merchants;
the purchasing proxy is of a plurality of transaction instrument proxies, each corresponding to the customer and to a different one of the merchants; and
the processor is further configured to freeze the purchasing proxy corresponding to a first of the merchants, and to not freeze the purchasing proxy corresponding to a second of the merchants, in response to a customer security breach.

8. The apparatus of claim 1 wherein:
the customer is of a plurality of customers;
the purchasing proxy is of a plurality of transaction instrument proxies, each corresponding to a different one of the customers and all corresponding to the merchant; and
the processor is further configured to freeze the plurality of transaction instrument proxies in response to a merchant security breach.

9. The apparatus of claim 8 wherein:
the receiver is configured to receive from each of the customers a panic signal; and
the processor is configured to freeze the proxies of those customers that transmit to the receiver the panic signal.

10. The apparatus of claim 9 wherein:
the processor is configured to:
detect a pattern based on communications from the customers; and
set a risk condition flag if the pattern satisfies a risk threshold; and
the transmitter is configured to transmit to the merchant, before freezing the plurality of transaction instrument proxies, the risk condition flag.

11. The apparatus of claim 10 wherein the processor is further configured to register in the machine readable memory a replacement proxy for each of the transaction instrument proxies in response to the risk condition flag.

12. The apparatus of claim 11 wherein the transmitter is configured to transmit to each of the customers the replacement proxies.

13. The apparatus of claim 1 wherein the processor is further configured to receive from the customer a purchasing proxy management instruction.

14. The apparatus of claim 13 wherein the merchant does not have access to the purchasing proxy management instruction.

15. The apparatus of claim 13 wherein the merchant does not have access to an outcome of the purchasing proxy management instruction.

16. The apparatus of claim 13 wherein:
the purchasing proxy is registered in a record in the machine readable memory;
the purchasing proxy management instruction results in a change in the record; and
the merchant does not have access to the change.

17. One or more computer-readable media storing computer-executable instructions which, when executed by a processor on a computer system, perform a method for processing a transaction between a customer and a merchant, the method comprising:
registering in a machine readable memory a purchasing proxy that corresponds to the customer and the merchant;
receiving from the merchant transaction information that includes the purchasing proxy; and
transmitting transaction authorization information to the merchant based on the transaction information and customer account information that is co-registered, in the machine readable memory, with the purchasing proxy.

18. The apparatus of claim 17 wherein the method further comprises transmitting to the customer a purchasing proxy alert that alerts the customer about use of the purchasing proxy in connection with a prospective transaction.

19. The apparatus of claim 17 wherein the method further comprises transmitting to the customer a purchasing proxy alert that alerts the customer about use of the purchasing proxy in connection with a transaction in progress.

20. The apparatus of claim 19 wherein the method further comprises canceling the transaction based on a customer response to the alert.

21. The apparatus of claim 19 wherein the method further comprises canceling the transaction based on a time elapsed after transmission of the alert and before receipt of a customer response.

22. The media of claim 17 wherein the method further comprises transmitting to the customer a purchasing proxy alert that alerts the customer about use of the purchasing proxy in connection with a completed transaction.

23. The media of claim 17 wherein:
the merchant is of a plurality of merchants;
the purchasing proxy is of a plurality of transaction instrument proxies, each corresponding to the customer and to a different one of the merchants; and
the method further comprises freezing the purchasing proxy corresponding to a first of the merchants, and not freezing the purchasing proxy corresponding to a second of the merchants, in response to a customer security breach.

24. The apparatus of claim 17 wherein:
the customer is of a plurality of customers;
the purchasing proxy is of a plurality of transaction instrument proxies, each corresponding to a different one of the customers and all corresponding to the merchant; and
the method further comprises freezing the plurality of transaction instrument proxies in response to a merchant security breach.

25. The apparatus of claim 24 wherein the method further comprises:
receiving from each of the customers a panic signal; and
freezing the proxies of those customers that transmit to the receiver the panic signal.

26. The apparatus of claim 25 wherein the method further comprises:
detecting a pattern based on communications from the customers;
setting a risk condition flag if the pattern satisfies a risk threshold; and
transmitting to the merchant, before freezing the plurality of transaction instrument proxies, the risk condition flag.

27. The apparatus of claim 26 wherein the method further comprises registering in the machine readable memory a replacement proxy for each of the transaction instrument proxies in response to the risk condition flag.

28. The apparatus of claim 27 wherein the method further comprises transmitting to each of the customers the replacement proxies.

29. The apparatus of claim 17 wherein the method further comprises receiving from the customer a purchasing proxy management instruction.

30. The apparatus of claim 29 wherein, in the method, the merchant does not have access to the purchasing proxy management instruction.

31. The apparatus of claim 29 wherein, in the method, the merchant does not have access to an outcome of the purchasing proxy management instruction.

32. The apparatus of claim 29 wherein, in the method:
the purchasing proxy is registered in a record in the machine readable memory;
the purchasing proxy management instruction results in a change in the record; and
the merchant does not have access to the change.

33. Apparatus for providing a transaction between a merchant and a customer that is one of a plurality of customers, the apparatus comprising:
a receiver that is configured to receive a customer response to a proxy alert;
a processor that is configured to set a risk condition flag based on the customer response; and
a transmitter that is configured to transmit to a merchant a transaction authorization request denial based on the risk condition flag.

34. The apparatus of claim 33 wherein:
the merchant is a first merchant;
the processor is configured to identify the customer as the source of the risk condition flag; and
the transmitter is configured to transmit to a second merchant a transaction authorization request approval based on an authorization request for a transaction between the customer and the second merchant.

35. The apparatus of claim 33 wherein:
the proxy alert corresponds to a purchasing proxy that is one of a plurality of purchasing proxies for the customer; and
the processor is further configured to receive a proxy management instruction from the customer, the proxy management instruction associating the purchasing proxy with a customer account of the customer.

36. Apparatus for providing a transaction between a merchant and a customer, the apparatus comprising:
a receiver configured to receive merchant security breach information; and
a processor that is configured to:
deny authorization requests for transactions between each of a plurality of customers and a first merchant; and
approve authorization requests for transactions between each of the plurality of customers and a second merchant.

37. The apparatus of claim 36 wherein:
the proxy alert corresponds to a purchasing proxy that is one of a plurality of purchasing proxies for the customer; and
the processor is further configured to receive a proxy management instruction from the customer, the proxy management instruction associating the purchasing proxy with a customer account of the customer.

38. The apparatus of claim 36 further comprising a transmitter;
wherein:
the receiver is configured to receive from a merchant a first request for authorization based on a purchasing proxy that is associated with a customer transaction instrument that is unknown to the merchant; and
the transmitter is configured to provide to an issuer a second request for authorization based on a customer account that is associated with the purchasing proxy and the transaction instrument.

39. The apparatus of claim 38 wherein the transmitter is further configured to provide to the merchant an approval of the first request, the approval including the purchasing proxy and not identifying the customer transaction instrument.
